(19) United States
(12) Patent Application Publication
(10) Pub. No.: US 2010/0060867 A1
(43) Pub. Date: Mar. 11, 2010

(54) PSEUDO LIGHT PIPE FOR COUPLING OF LIGHT FOR DUAL PARABOLOID REFLECTOR (DPR) SYSTEM

(76) Inventor: KENNETH LI, Castaic, CA (US)

Correspondence Address: FULBRIGHT & JAWORSKI, LLP, 666 FIFTH AVE, NEW YORK, NY, 10103-3198, US

(21) Appl. No.: 12/555,316

(22) Filed: Sep. 8, 2009

Related U.S. Application Data
(60) Provisional application No. 61/191,034, filed on Sep. 5, 2008.
(60) Provisional application No. 61/233,165, filed on Aug. 12, 2009.

(51) Int. Cl. G03B 21/28; G02B 6/00; G02B 27/30

(52) U.S. Cl. 353/99; 362/551; 359/641; 353/20

(57) ABSTRACT

A pseudo light pipe comprises an input end, an output end and a light transmission medium. The input end collects rays of light from a light source. The output end outputs and collimates the rays of the light collected at the input end. The output end has a convex curvature. The light transmission medium interconnects the input and output end, and transmits the rays of the light from the input end to the output end. The convex curvature of the output end is selected to output parallel rays of light. A projection system incorporating the pseudo light pipe and a dual paraboloid reflector (DPR) system.

### CROSS-REFERENCE TO RELATED APPLICATIONS

This application claims the benefit of U.S. Provisional Application Ser. No. 61/191,034 filed Sep. 5, 2008, and U.S. Provisional Application Ser. No. 61/233,165 filed Aug. 12, 2009, each of which is incorporated by reference in its entirety.

### TECHNICAL FIELD OF INVENTION

This invention relates to a light pipe, more particularly to a pseudo light pipe that operates and functions as a tapered light pipe but is easier to mount and manufacture than a tapered light pipe. The convex curvature of the output end of the pseudo light pipe is selected to provide output with certain divergence and in particular, to provide output parallel rays of light.

### BACKGROUND OF THE INVENTION

Tapered light pipe (TLP) is used in many applications to transform a source of light from one area/angle combination to another with substantially the same brightness. The taper angle and length is designed such that there will be minimum loss of brightness. In practical applications, the length is shorter than desired. In such case, the input and output surface are made concave and convex respectively, such that the tapered light pipe appears to be straight to the input and output light. The manufacturing and mounting of the TLP are generally tedious and expensive. Accordingly, the claimed invention proceeds upon the desirability of providing a TLP with a lower cost of fabrication and mounting.

### SUMMARY OF THE INVENTION

Therefore, it is an object of the claimed invention to provide a pseudo light pipe that solves the aforesaid problems with the TLP.

In accordance with an exemplary embodiment of the claimed invention, a pseudo light pipe comprises an input end, an output end and a light transmission medium. The input end collects rays of light from a light source. The input end generally comprises a flat surface. Alternatively, a portion of the input end can have a concave curvature. The output end outputs and collimates the rays of the light collected at the input end. The output end has a convex curvature. Preferably, the curvature of the output end is selected to minimize the etendue mismatch between the input end and the output end. The light transmission medium interconnects the input and output end, and transmits the rays of the light from the input end to the output end. The convex curvature of the output end is selected to output parallel rays of light. Preferably, the surface of the input and output ends of the pseudo light pipe is coated with anti-reflective coating. In accordance with an aspect of the claimed invention, the pseudo light pipe further comprises a mounting surface for mounting the pseudo light pipe.

In accordance with an exemplary embodiment of the claimed invention, a projection system comprises a projection engine, a light source and a pseudo light pipe. The light source comprises a lamp, a dual paraboloid reflector (DPR) and a retro-reflector, which collects and re-directs the stray rays of light to the DPR. The pseudo light pipe comprises an input end, an output end and a light transmission medium. The input end collects rays of light from a light source. The output end outputs and collimates the rays of the light collected at the input end. The output end has a convex curvature. The light transmission medium interconnects the input and output end, and transmits the rays of the light from the input end to the output end. The convex curvature of the output end is selected to output parallel rays of light. The projection system optionally comprises a fly eye lens and a polarization conversion system between the output end of the pseudo light pipe and the projection engine. Preferably, the projection engine is a liquid crystal display (LCD) or liquid crystal on silicon (LCOS) projection engine.

In accordance with an exemplary embodiment of the claimed invention, the pseudo light pipe can be used any one of the following light source: a LED, a microwave lamp, an ultra-high pressure mercury lamp, a microwave driven electrodeless lamp, metal halide lamp, fluorescent lamp, and halogen lamp. The light source can combine the lamp with one of the following: a dual paraboloid reflector (DPR), a DPR with a retro-reflector, an elliptical reflector, a parabolic reflector with focusing lens or a dual ellipsoidal reflector (DER) system. The retro-reflector collects and redirects the stray rays of light to the DPR.

In accordance with an exemplary embodiment of the claimed invention, the light source is positioned near the input end and at a focal point of the output end.

In accordance with an exemplary embodiment of the claimed invention, the light transmission medium has a round, rectangular or polygonal cross-sectional area. The light transmission medium is made from at least one of the following material: glass, fused silica, plastic, and quartz.

In accordance with an exemplary embodiment of the claimed invention, the convex curvature of the output end is one of the following conical shape: parabolic, hyperbolic, or spherical. In general, the convex curvature can be numerically generated surface. Preferably, the convex curvature of the output end is an ellipse.

In accordance with an exemplary embodiment of the claimed invention, the light transmission medium comprises a plurality of sections. Each section of said light transmission medium is made from one of the following material: glass, fused silica, plastic and quartz. Preferably, a section comprising the input end is made from high temperature material and a section comprising said output end is molded with low temperature glass or plastic. In accordance with an aspect of the claimed invention, the light transmission medium comprises an air gap between each section of said light transmission medium. In accordance with an aspect of the claimed invention, each section of said light transmission medium is made from a different material. The light transmission medium can comprise an input section of air and output section made from one of the following material: glass, fused silica, plastic and quartz.

In accordance with an exemplary embodiment of the claimed invention, the curvature of the output end is astigmatic such that the output curvature is different in the two perpendicular directions.

Various other objects, advantages and features of the claimed invention will become readily apparent from the ensuing detailed description, and the novel features will be particularly pointed out in the appended claims.

### BRIEF DESCRIPTION OF THE DRAWINGS

The following detailed description, given by way of example, and not intended to limit the claimed invention solely thereto, will best be understood in conjunction with the accompanying drawings in which like components or features in the various figures are represented by like reference numbers:

FIG. 1 shows a cross-sectional view of a dual paraboloid reflector system with a tapered light pipe;

FIG. 2 shows a cross-sectional view of a tapered light pipe;

FIG. 3 shows a cross-sectional view of a pseudo light pipe (PLP) in accordance with an exemplary embodiment of the claimed invention;

FIG. 4 shows a perspective view of the PLP in accordance with an exemplary embodiment of the claimed invention;

FIG. 5 shows a perspective view of the PLP with a rectangular cross-section in accordance with an exemplary embodiment of the claimed invention;

FIG. 6 shows a cross-sectional view of the PLP with a concaved input end in accordance with an exemplary embodiment of the claimed invention;

FIG. 7 shows a cross-sectional view of the PLP fabricated with a combination of material in accordance with an exemplary embodiment of the claimed invention;

FIG. 8 shows cross-sectional view of the PLP with a light source of dimension d in accordance with an exemplary embodiment of the claimed invention;

FIG. 9 shows a cross-sectional view of a projection system incorporating the PLP based DPR in accordance with an exemplary embodiment of the claimed invention;

FIG. 10 shows a cross-sectional view of the PLP with a portion of the output end coated with a reflective coating in accordance with an exemplary embodiment of the claimed invention;

FIGS. 11(A)-(C) show cross-sectional views of the output end of the PLP comprising a retro-reflective portion in accordance with an exemplary embodiment of the claimed invention; and

FIG. 12 is a perspective view of an astigmatic PLP in accordance with an exemplary embodiment of the claimed invention.

### DETAILED DESCRIPTION OF THE EMBODIMENTS

With reference to the figures, exemplary embodiments of the claimed invention are now described. These embodiments illustrate principles of the invention and should not be construed as limiting the scope of the invention.

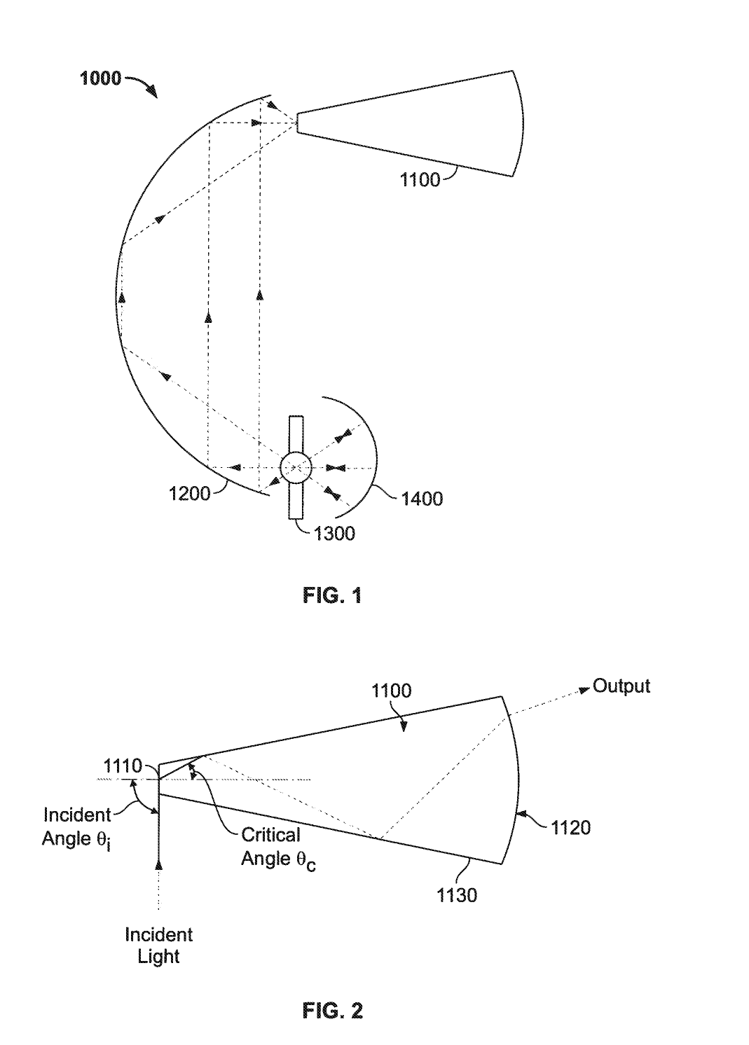

FIG. 1 shows a dual Paraboloid reflector (DPR) system 1000 used in conjunction with a tapered light pipe (TLP) 1100 showing that the small area, large angle Θᵢ light incidence at the input of the TLP 1100 is transformed to a larger area, smaller angle at the output. The DPR system 1000 comprises a DPR 1200, a lamp 1300, and a retro-reflector 1400. The arc images onto the input end or surface 1110 of the TLP 1100 using the DPR 1200, which preserve the brightness of the arc. The size of the TLP 1100 is designed based on the etendue of the DPR system 1000, which determines the input and output dimensions of the TLP 1100. The length of the TLP 1100 is generally determined by mechanical limitations and shorter TLPs 1100 are generally preferred.

As the TLPs 1100 get shorter, the transformation become non-ideal and the output has a slightly larger etendue than at the input. To overcome this etendue mismatch between the output and input, a TLP 1100 with the output end or surface 1120 having a convex surface (as shown in FIG. 2) instead of a flat surface (as shown in FIG. 1) can be utilized. That is, the convexity or the curvature of the output surface 1120 is selected such that the output etendue of the TLP 1100 matches or near the input etendue of the TLP 1100. When light enters into the tapered light pipe (TLP) 1100, the light bounces multiple times off the sidewalls 1130 of the TLP 1100 depending on the angle of incidence Θᵢ of the light, the taper angle of the TLP 1100, and the length of the TLP 1100. As the length of the TLP 1100 decreases (i.e., a short TLP 1100), the curvature of the output surface 1120 of the TLP 1100 needs to increase to make the necessary correction to the input/output etendue mismatch. It is appreciated that if the curvature of the convex output surface 1120 increases too much, it will become non-spherical, e.g., elliptical, and additional calculation will be required to achieve optimum performance.

Also, FIG. 2 shows the extreme input angle such that the ray inside the TLP 1100 has a critical angle Θ_{c}, and hits the sidewall of the TLP 1100. The TLP 1100 comprises an input end 1110 and an output end 1120. Preferably, the output end 1120 of the TLP 1100 is a convex surface. The multiple bounces or reflections off the sidewalls 1130 of the TLP 1100 operate to mix the light to provide a light output intensity that is uniform in profile. That is, the TLP 1100 functions as a light mixing device.

Another effect of having a short TLP 1100 is that when the angle Θ is larger than the critical angle Θ_{c}, the incident light will not be reflected by the sidewalls 1130 of the TLP 1100. In such a case, the TLP 1100 acts as a thick lens more than a tapered light pipe as the incident light exits without any reflection off the sidewall 1130. In accordance with an exemplary embodiment of the claimed invention, the curvature of the output end 1120 of the TLP 1100 is calculated and determined such that the nominal ray from the center of the input end 1110 will be parallel at the output end 1120. Since the sidewall 1130 of the TLP 1100 is not used, the TLP 1 100 can be made simply as a straight rectangular or cylindrical rod.

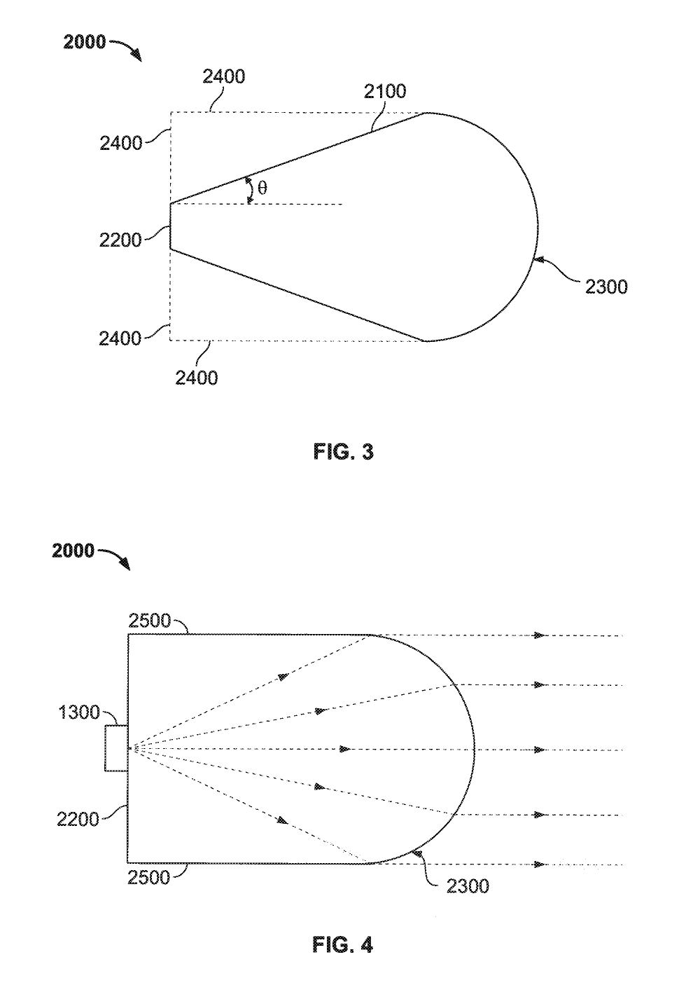

In accordance with an exemplary embodiment of the present invention, a pseudo light pipe (PLP) or virtual tapered light pipe 2000 is shown in FIGS. 3 and 4 where the sidewalls exist conceptually, but are not functional and not needed. The PLP 2000 comprises an input end or surface 2200 and output end or surface 2300. Preferably, the output end 2300 of the PLP 2000 is a convex surface where the curvature is calculated and determined to optimize performance. The virtual sidewall 2100 is at an angle theta (Θ) with the direction of the PLP 2000 such that the virtual sidewall angle θ is adjusted to match with the maximum incident angle Θᵢ. For example, if the maximum input or incident angle Θᵢ is 90 degrees, which is the glazing angle, then the virtual sidewall angle Θ will become the critical angle Θ_{c}. If the virtual sidewall angle Θ is at the critical angle Θ_{c}, the extreme rays of light (input rays of light with an incident angle Θᵢ near or at the critical angle Θ_{c}) from the light source 1300 will propagate along the virtual sidewall 2100, but will not be incident on the virtual sidewall 2100. As a result, the sidewall of the PLP 2000 becomes a virtual sidewall without any actual functions.

To facilitate the fabrication of the PLP 2000, in accordance with an exemplary embodiment of the claimed invention, actual boundary or extra surfaces 2400 are added to the PLP 2000. The actual boundary or extra surfaces 2400 also serve no functional purpose, but facilitate mechanical mounting of the PLP 2000 into systems, such as projection and illumination systems. In accordance with an exemplary embodiment of the claimed invention, an outer boundary or shape of the PLP 2000 is shown in FIG. 4. The outer boundary of the PLP 2000 comprises one or more mounting surfaces 2500, an output end or surface 2300, and an input end or surface 2200. It is appreciated that the cross-section of the PLP 2000 can be round, rectangular; polygonal and the like depending on the application of the PLP 2000. Accordingly, the mounting surface 2500 of the PLP 2000 is essentially equivalent to the sidewalls 1130 of the TLP 1100.

In accordance with an exemplary embodiment of claimed invention, the PLP 2000 can be used with various light sources 1300 including but not limited to LED, microwave lamp, ultra-high pressure mercury lamp, microwave driven electrode-less lamp, metal halide lamp, fluorescent lamp, halogen lamp, or other comparable lamps. The light source 1300 can be placed at the focus of light source with reflectors, e.g., a dual paraboloid reflector (DPR), elliptical, parabolic with focusing lens, or a dual elliptical reflector (DER). In accordance with an aspect of the claimed invention, the PLP 2000 can be rotationally symmetric as a round device, non-symmetric in the two directions giving astigmatic output convex surface, or can be linear with a circular or elliptical cross-section for linear lamp applications.

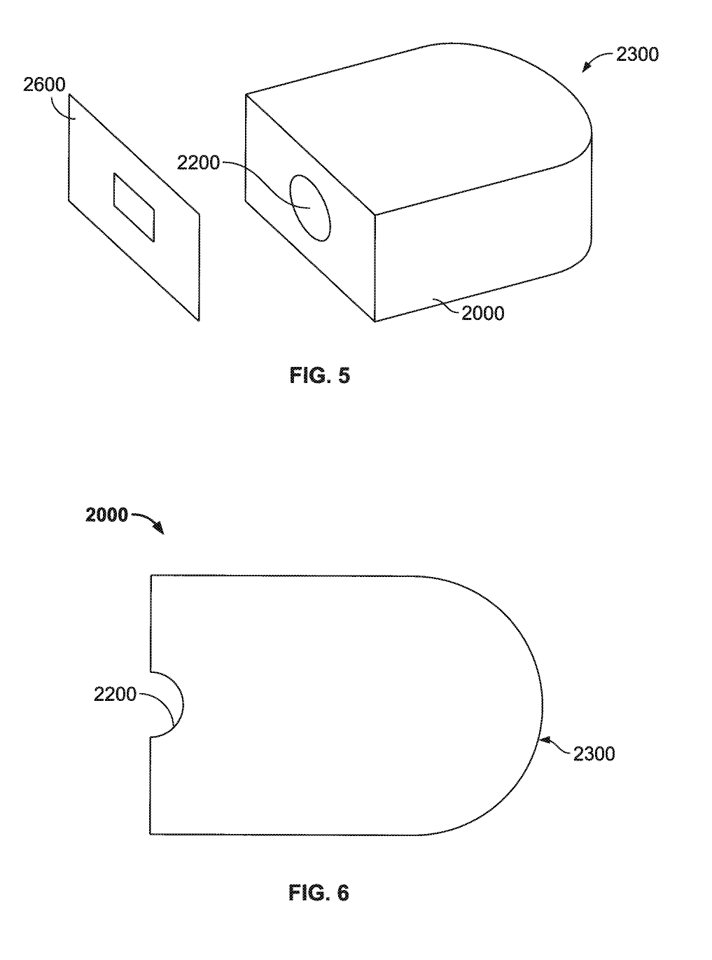

In accordance with an exemplary embodiment of the claimed invention, the cross-section of the PLP 2000 is rectangular and the output end 2300 is a convex surface. That is, as shown in FIG. 5, the input end 2200 of the PLP is rectangular in shape. Additionally, the PLP 2000 can comprise an optional mask 2600 at the input end 2200 for filtering input rays of light such that extreme rays of light (input rays of light with an incident angle Θᵢ near or at the critical angle Θ_{c}) is at a desired angle for hitting the output end or surface 2300 of the PLP 2000. The optical mask has the effect of limiting the etendue of the system such that not the whole light source is used. This is similar to the input aperture of the standard tapered light pipe, in which the light pipe is designed for a specific etendue. When the mask is not used and the output consist the full etendue of the light source and is made available for the application. As a result, the etendue of the system is limited by the subsequent components, e.g., relay lens, imaging panel, projections lens, or the aperture.

In accordance with an exemplary embodiment of the claimed invention, the curvature of the output end 2300 of the PLP 2000 is an ellipse for collimating the rays of light. Alternatively, the curvature of the output end 2300 of the PLP 2000 can be different shape to provide different level of collimation, such as a conic shape including but not limited to parabolic, hyperbolic, and spherical.

Turning now to FIG. 6, in accordance with an exemplary embodiment of the claimed invention, there is illustrated a PLP 2000 with an input end 2200, which is concaved. It is appreciated that the concaved input end 2200 can provide a better coupling or a better match with the system incorporating the PLP 2000. However, in certain applications, the additional performance improvement may not justify the additional cost of fabricating the PLP 2000 with the concaved input end 2200.

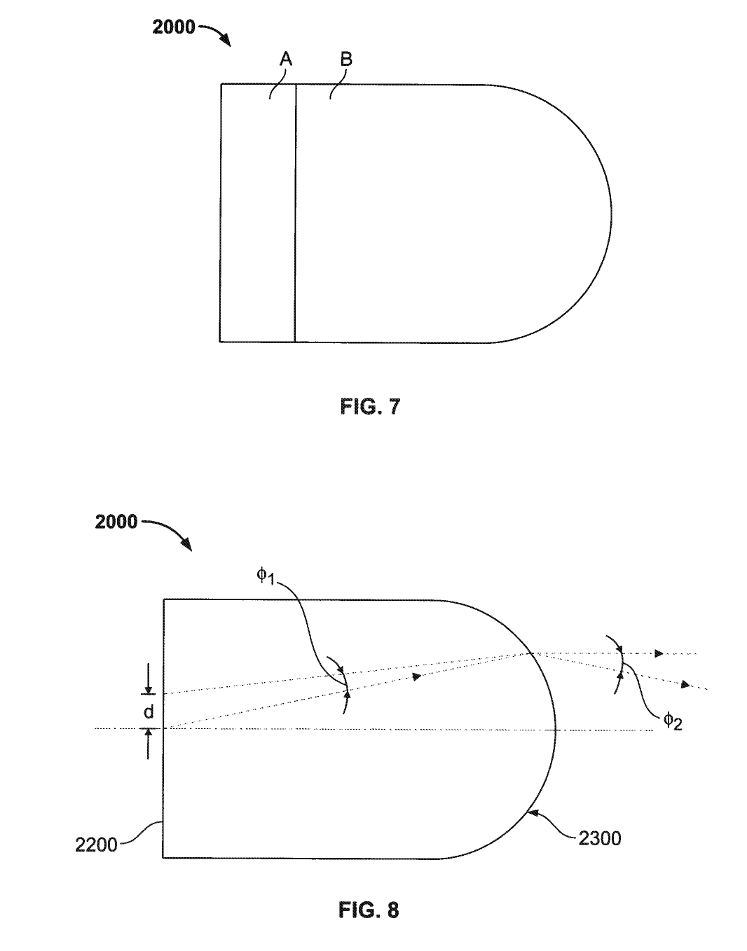

The PLP 2000 can be made from plastic, glass, fused silica, quartz and the like depending on the power density requirements of the system incorporating the PLP 2000. In accordance with the exemplary embodiment of the claimed invention, as shown in FIG. 7, the PLP 2000 can also fabricated from multiple sections such that the section comprising the input end 2200 of the PLP 2000 can be made with high temperature material and attached to the curved section of the output end 2300, which can be molded with low temperature glass or plastic. In accordance with an aspect of the claimed invention, each section of the PLP 2000 can be separated by an air gap. That is, the PLP 2000 can be fabricated from a combination of these materials (e.g., plastic, glass, fused silica, quartz and the like) such that higher melting temperature materials can be placed on the higher intensity side. For example, the PLP 2000 can be fabricated from a glass/plastic combination where section A comprising the input end 2200 is made of glass and section B comprising the output end 2300 is made of plastic. Section A is close to the focus of the light source and receives high power density. The light beam spreads along its path within the PLP 2000 and towards section B made of plastic. In accordance with an aspect of the claimed invention, Section A can be fabricated from quartz for very high power density applications and Section B can be fabricated from glass or plastic. Various other combinations of materials can be also used in fabricating the PLP 2000, such as a lens for Section B and a transparent material for Section A which can be air, same or different from lens in Section B. In general, there can be more than 2 layers of different materials.

In accordance with an exemplary embodiment of the claimed invention, various surfaces of the PLP 2000 can be coated with a single or multiple layers of anti-reflective material.

Since the actual boundary surfaces 2400 of the PLP 2000 is not used optically, as exemplary shown in FIG. 3, the boundary surfaces 2400 does not have to be polished. In accordance with an exemplary embodiment of the claimed invention, the boundary surfaces 2400 of the PLP 2000 can be textual for ease of mounting.

In accordance with an exemplary embodiment of the claimed invention, the curvature of the input and output surface 2200, 2300 are optimized by analytical formulas or by ray tracing. Typically, a light source 1300 is not a point source, but has a dimension d, as shown in FIG. 8. That is, the light source 1300 generates an input beam with a dimension d. Rays or beam of light from such light source 1300 will subtend an angle φ₁ inside the PLP 2000 and will exit the output end 2300 of the PLP 2000 at an output angle φ₂. As the size of the PLP 2000 increases, the angle φ₁ will decrease resulting in a smaller output angle φ₂ for the same light source with dimension d. That is, the area of the input surface/end 2200 and the output surface/end 2300 of the PLP 2000 will increase with the size of the PLP 2000. This results in conservation of etendue or minimizes the input/output etendue mismatch. As a result, a smaller PLP 2000 will have a larger output angle φ₂, but a smaller output surface area 2300. A larger PLP 2000 will have a smaller output angle φ₂, but a larger output surface area 2300.

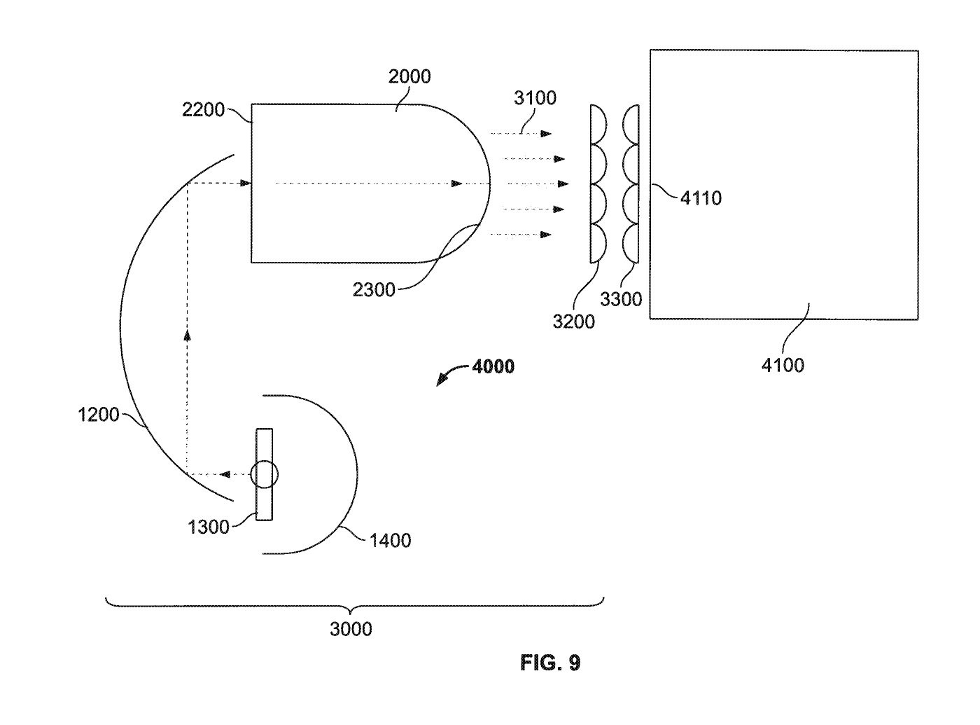

Turning now to FIG. 9, there is illustrated an exemplary application of the PLP 2000 in accordance with an exemplary embodiment of the claimed invention. The DPR system 3000 of FIG. 9 is similar to the DPR system 1000 of FIG. 1. Instead of incorporating the TLP 1100, the DPR system 3000 incorporates the PLP 2000 in accordance with an exemplary embodiment of the claimed invention. The DPR system 3000 can be used with a liquid crystal display (LCD) or liquid crystal on silicon (LCOS) projection engine 4100 to provide an illumination/projection system 4000. The collimated light output 3100 from the PLP 2000 is inputted into the LCD/LCOS projection engine 4100. Alternatively, the projection system 4000 comprises an optional fly eye lens 3100 and/or an optional polarization conversion system between the output end 2300 of the PLP 2000 and the input end 4110 of the LCD/LCOS projection engine 4100. That is, the collimated light output 3100 is incident on an optional fly eye lens 3100 and/or an optional polarization conversion system 3200 before entering the LCD/LCOS projection engine 4100. It is appreciated that the light source or lamp 1300 can be LED, ultra-high pressure mercury lamp, microwave driven electrode-less lamp, metal halide lamp, or other lamps suitable for use with the DPR system 3000.

In accordance with an exemplary embodiment of the claimed invention, the curvature of the output end 2300 of the PLP 2000 can be astigmatic with different curvature in the two perpendicular directions, as exemplary shown in FIG. 121 The curvature of the output end 2300 in X and Y direction can be same or different to provide an astigmatic PLP 2000.

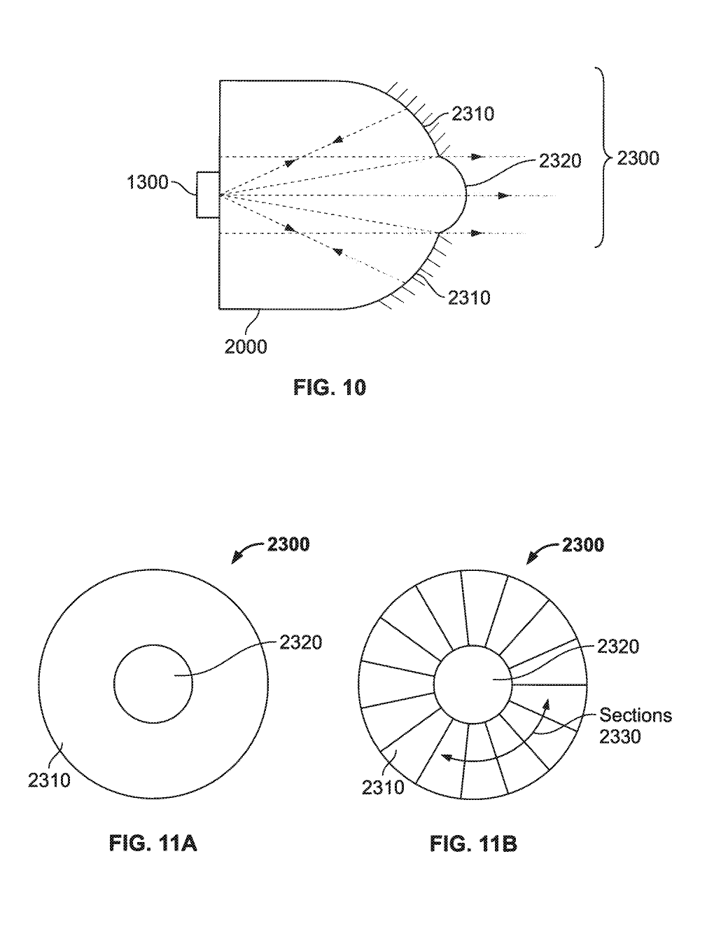

In accordance with an exemplary embodiment of the claimed invention, as shown in FIG. 10, the output end 2300 of the PLP 2000 comprises a retro-reflective portion 2310, preferably a spherical in shape. The retro-reflective portion 2310 of the output end 2300 is coated with a reflective coating or coupled to a reflector to provide retro-reflection. That is, the retro-reflective portion 2310 reflects a portion or part of the light emitted by the light source 1300 back into the light source 1300 to provide recycling of the light via retro-reflection.

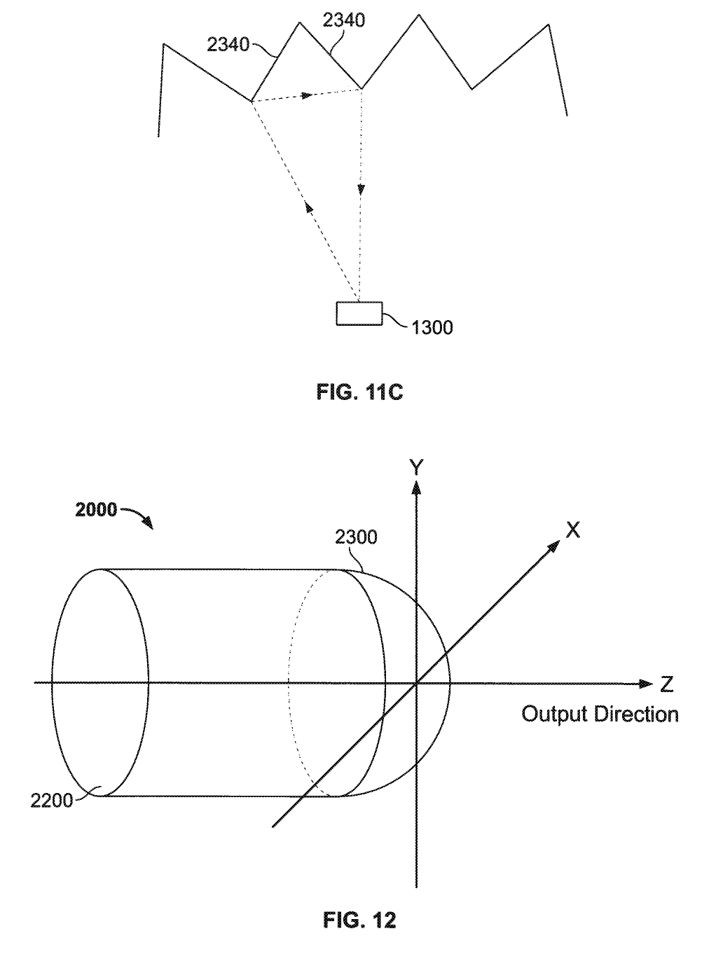

Turning now to FIG. 11(A), there is illustrated a perspective view of the output end 2300 of the PLP 2000 with recycling. The output end or surface 2300 of the PLP comprises a collimating surface 2320 for outputting a collimated light and a retro-reflective portion 2310 for reflecting a portion of the emitted light back to the input end 2200 and to the light source 1300. In accordance with an exemplary embodiment of the claimed invention, as shown in FIGS. 11(B) and 11(C), the retro-reflective portion 2310 comprises a plurality of retro-reflective sections 2330. Each retro-reflective section 2330 comprises a parabolic surface pairs 2340, such that light incident on a first parabolic surface 2340 collimates onto the second parabolic surface 2340 (as shown in FIG. 11(C)), and focused back into the light source 1300. The number and size of the retro-reflective sections 2330 is determined such that all reflections off the parabolic surface pairs 2340 is by total internal reflection, thereby eliminating the need to coat the retro-reflective portion 2310 with a reflective coating. Additionally, this advantageously lowers the cost of manufacturing the claimed PLP 2000, particularly when the PLP 2000 is fabricated by a molding process.

The invention, having been described, it will be apparent to those skilled in the art that the same may be varied in many ways without departing from the spirit and scope of the invention. Any and all such modifications are intended to be included within the scope of the following claims.

1. A pseudo light pipe, comprising:
an input end for collecting rays of light from a light source;
an output end for outputting and collimating said rays of the light collected at said input end, said output end having a convex curvature; and
a light transmission medium interconnecting said input end and said output end for transmitting said rays of the light from said input end to said output end; and
wherein said convex curvature of said output end is selected to output parallel rays of light.

2. The pseudo light pipe of claim 1, wherein the light source is positioned near said input end and at a focal point of said output end.

3. The pseudo light pipe of claim 1, wherein said light transmission medium has a round, rectangular or polygonal cross-sectional area.

4. The pseudo light pipe of claim 1, wherein said convex curvature of said output end is an ellipse.

5. The pseudo light pipe of claim 1, wherein said convex curvature of said output end is one of the following conical shape: parabolic, hyperbolic, or spherical.

6. The pseudo light pipe of claim 1, wherein said light transmission medium is made from at least one of the following material: glass, fused silica, plastic, and quartz.

7. The pseudo light pipe of claim 1, wherein said light transmission medium comprises a plurality of sections, wherein a section comprising said input end is made from high temperature material.

8. The pseudo light pipe of claim 7, wherein each section of said light transmission medium is made from one of the following material: glass, fused silica, plastic and quartz.

9. The pseudo light pipe of claim 8, wherein a section comprising said output end is molded with low temperature glass or plastic.

10. The pseudo light pipe of claim 8, further comprising an air gap between each section of said light transmission medium.

11. The pseudo light pipe of claim 8, wherein each section of said light transmission medium is made from a different material.

12. The pseudo light pipe of claim 1, wherein said light transmission medium comprises an input section of air and output section made from one of the following material: glass, fused silica, plastic and quartz.

13. The pseudo light pipe of claim 1, wherein a portion of said input end has a concave curvature.

14. The pseudo light pipe of claim 1, wherein the curvature of said output end is astigmatic such that the curvature is different in the two perpendicular directions.

15. The pseudo light pipe of claim 1, wherein the curvature of said output end is selected to minimize etendue mismatch between said input end and said output end.

16. The pseudo light pipe of claim 1, further comprising a mounting surface for mounting the pseudo light pipe.

17. The pseudo light pipe of claim 1, wherein surface of said input end and said output end is coated with anti-reflection coating.

18. The pseudo light pipe of claim 1, wherein the light source is one of the following lamp: a LED, a microwave lamp, an ultra-high pressure mercury lamp, a microwave driven electrodeless lamp, metal halide lamp, fluorescent lamp, and halogen lamp.

19. The pseudo light pipe of claim 18, wherein the light source comprises the lamp with a dual paraboloid reflector (DPR), a DPR with a retro-reflector, an elliptical reflector, a parabolic reflector with focusing lens, or a dual elliptical reflector (DER).

20. The pseudo light pipe of claim 19, wherein the light source comprises the lamp with the DPR with a retro-reflector, said retro-reflector collecting and redirecting stray rays of light to the DPR; and wherein the parallel rays of light output from said output end is incident on a projection engine.

21. The pseudo light pipe of claim 20, wherein the projection engine is a liquid crystal display (LCD) or liquid crystal on silicon (LCOS) projection engine.

22. The pseudo light pipe of claim 20, wherein the parallel rays of light output from said output end is incident on a fly eye lens and then enters the projection engine.

23. The pseudo light pipe of claim 21, wherein the parallel rays of light output from said output end is incident on a fly eye lens and a polarization conversion system, and then enters the projection engine.

24. A projection system, comprising:
a projection engine;
a light source comprising a lamp, a dual paraboloid reflector (DPR) and a retro-reflector for collecting and re-directing stray rays of light to the DPR; and
a pseudo light pipe comprising:
an input end for collecting rays of light from the light source;
an output end for outputting and collimating said rays of the light collected at said first end, said output end having a convex curvature;
a light transmission medium interconnecting said first end and said second end for transmitting said rays of the light from said first end to said second end; and
wherein said convex curvature of said output end is selected to output parallel rays of light to the projection engine.

25. The projection system of claim 24, wherein the projection engine is a liquid crystal display (LCD) or liquid crystal on silicon (LCOS) projection engine.

26. The projection system of claim 24, further comprising a fly eye lens between said output end of said pseudo light pipe and the projection engine.

27. The projection system of claim 26, further comprising a polarization conversion system between said fly eye lens and the projection engine.
